(19) United States
(12) Patent Application Publication
(10) Pub. No.: US 2022/0372973 A1
(43) Pub. Date: Nov. 24, 2022

(54) TURBOMACHINE PROVIDED WITH AN ELECTROMAGNETIC PUMP WITH AXIAL MAGNETIC FLUX

(71) Applicant: SAFRAN HELICOPTER ENGINES, BORDES (FR)

(72) Inventors: Franck Albert Robert DUPEU, Moissy-Cramayel (FR); Jean-Marie André Robert GIGON, Moissy-Cramayel (FR); Pascal Jean-Dominique MINGRET, Moissy-Cramayel (FR)

(73) Assignee: SAFRAN HELICOPTER ENGINES, BORDES (FR)

(21) Appl. No.: 17/755,170

(22) PCT Filed: Oct. 16, 2020
(86) PCT No.: PCT/FR2020/051855

§ 371 Date: Apr. 22, 2022

(30) Foreign Application Priority Data
Oct. 25, 2019 (FR) 1911967

(51) Int. Cl. F04C 2/10; F04C 15/00; F04C 7/00; F02C 7/32

(52) U.S. Cl. CPC F04C 2/10; F04C 15/0069; F04C 7/00; F02C 7/32

(57) ABSTRACT

A turbomachine comprises a rotating spool comprising a drive shaft delivering mechanical power. The turbomachine comprises an electromagnetic pump mechanically decoupled from the drive shaft. The electromagnetic pump comprises at least one stator delimiting an annular internal volume in which is present a rotor able to drive a fluid, a plurality of magnets distributed annularly on the rotor and at least one plurality of coils distributed annularly inside the rotor. The coils of the plurality of coils face magnets along an axial direction.

### CROSS-REFERENCE TO RELATED APPLICATIONS

This application is a National Stage Application of International Application PCT/FR2020/051855, filed on Oct. 16, 2020, now published as WO 2021/079048 A1, and which claims priority to French patent application FR1911967, filed on Oct. 25, 2019, which is incorporated by reference herein in its entirety.

### TECHNICAL FIELD

The present invention relates to the field of turbomachines of the type comprising a rotating spool comprising a drive shaft delivering mechanical power.

The invention applies to any type of turbomachine, in particular those used in aircraft such as turbojets, turboprops and turbomachines with unshrouded fans, also known by the designation of “Open Rotor.”

### PRIOR ART

A conventional turbomachine includes, in known fashion, one or more rotating spools. Each rotating spool comprises a compressor, a turbine and a drive shaft connecting the turbine to the compressor to drive the compressor in rotation. A part of the power generated by the turbomachine is used to drive different accessories (or auxiliary machines) necessary for the operation of the turbojet or of the aircraft, such as for example a lubrication pump or a fuel pump.

To this end, the turbomachine generally comprises an accessory gearbox connecting the drive shaft to the pumps. When the drive shaft is driven in rotation, the accessory gearbox transmits the rotation movement to the different accessories. In other words, the mechanical energy produced by the drive shaft is transmitted to the pumps by the accessory gearbox.

This technical solution has, however, the following disadvantages:
a portion of the mechanical power delivered by the rotating spool is extracted to drive the pump(s),
the speed of rotation of the pump(s) depends on the speed of rotation of the drive shaft, the pump(s) not then being controllable according to an independent drive speed,
the mechanical connection between the drive shaft and the pump(s) necessitates dynamic seal qualities which are difficult to achieve,
the mechanical connection between the drive shaft and the pump(s) requires placing the pump(s) in proximity to the accessory gearbox, which greatly limits the possibilities of installation of the pump(s) in a turbomachine.

### DISCLOSURE OF THE INVENTION

The invention has as its purpose in particular to provide a turbomachine that does not have the aforementioned disadvantages.

This purpose is achieved due to a turbomachine comprising a rotating spool comprising a drive shaft delivering mechanical power, characterized in that it comprises at least one electromagnetic pump mechanically decoupled from the drive shaft, each electromagnetic pump comprising at least one stator delimiting an annular internal volume in which is present a rotor able to drive a fluid, a plurality of magnets distributed annularly on the rotor and at least one plurality of coils distributed annularly inside the stator, the coils of the plurality of coils facing the magnets along an axial direction.

The turbomachine according to the invention is thus equipped with one or more pumps which are mechanically decoupled from the drive shaft and which are controlled independently of the shaft speed. It is thus possible to have greater freedom of choice of the rotation seed of the pump and in the installation possibilities of the pump(s) in the turbomachine.

In addition, by placing the plurality of permanent magnets and the plurality of coils facing one another along the axial direction, the radial bulk of the pump is greatly optimized. A very compact pump is thereby obtained.

According to a particular characteristic of the turbomachine of the invention, the rotor comprises a wheel provided with a plurality of vanes, the magnets of the plurality of magnets being held at the outer periphery of the wheel.

According to another particular characteristic of the turbomachine of the invention, each electromagnetic pump comprises first and second pluralities of coils, present respectively on one side and on the other side of the wheel, the coils of the first and second pluralities of coils facing the magnets along the axial direction. Two pluralities of the coils allow ensuring redundancy in the event of a breakdown or failure of one plurality of coils. The redundancy of the plurality of coils can also be used to double the power of the electromagnetic fields to which the permanent magnets are subjected.

According to another particular feature of the turbomachine of the invention, the rotor comprises an inner gear cooperating with an outer ring gear with inner teeth, the magnets of the plurality of magnets being held at the outer periphery of the outer ring gear.

According to another particular feature of the turbomachine of the invention, each electromagnetic pump comprises first and second pluralities of coils, present respectively on one side and on the other side of the outer ring gear, the coils of the first and second pluralities of coils facing the magnets along the axial direction. The use of two pluralities of coils allows ensuring redundancy in the event of a breakdown or a failure of one plurality of coils and/or doubling the power of the electromagnetic fields to which the permanent magnets are subjected.

According to another particular feature of the turbomachine of the invention, the rotor comprises an inner gear cooperating with an outer ring gear with inner teeth, the magnets of the plurality of magnets being held on the inner gear.

According to another particular feature of the turbomachine of the invention, each electromagnetic pump comprises first and second pluralities of coils, present respectively on one side and on the other side of the gear, the coils of the first and second pluralities of coils facing the magnets along the axial direction. The use of two pluralities of coils allows ensuring redundancy in the event of a breakdown or a failure of one plurality of coils and/or doubling the power of the electromagnetic fields to which the permanent magnets are subjected.

According to another particular feature of the turbomachine of the invention, the magnets of the plurality of magnets are arranged annularly in a Halbach structure. This particular arrangement allows increasing the magnetic field on the outside of the rotor while the magnetic field on the inside of the rotor is substantially cancelled. The dissipation of the magnetic field is thus reduced, which improves the control of the rotor by the coils.

The invention also has as its object an aircraft comprising at least one turboprop or one turbojet comprising a turbomachine according to the invention.

### BRIEF DESCRIPTION OF THE DRAWINGS

FIG. 1 is a schematic view in exploded perspective of an electromagnetic pump conforming with a first embodiment of the invention,

FIG. 2 is another schematic view in exploded perspective of an electromagnetic pump conforming with the first embodiment of the invention,

FIG. 3 is a schematic view in exploded perspective of an electromagnetic pump conforming with a second embodiment of the invention,

FIG. 4 is another schematic view in exploded perspective of an electromagnetic pump conforming with the second embodiment of the invention,

FIG. 5 is a schematic view in exploded perspective of an electromagnetic pump conforming with a third embodiment of the invention,

FIG. 6 is another schematic view in exploded perspective of an electromagnetic pump conforming with the third embodiment of the invention,

FIG. 7 is a schematic view in exploded perspective of an electromagnetic pump conforming with a fourth embodiment of the invention,

FIG. 8 is another schematic view in exploded perspective of an electromagnetic pump conforming with the fourth embodiment of the invention,

FIG. 9 is a schematic view in exploded perspective of an electromagnetic pump conforming with a fifth embodiment of the invention,

FIG. 10 is another schematic view in exploded perspective of an electromagnetic pump conforming with the fifth embodiment of the invention,

FIG. 11 shows an annular arrangement of permanent magnets according to a Halbach structure,

FIG. 12 is a schematic representation of a turbomachine according to the invention.

### DESCRIPTION OF THE EMBODIMENTS

The invention applies generally to any turbomachine equipped with at least one pump controlled independently of the engine speed of the turbomachine. It applies particularly, but not exclusively, to pumps of the liquid ring, with a lateral or regenerative channel, and gerotor type.

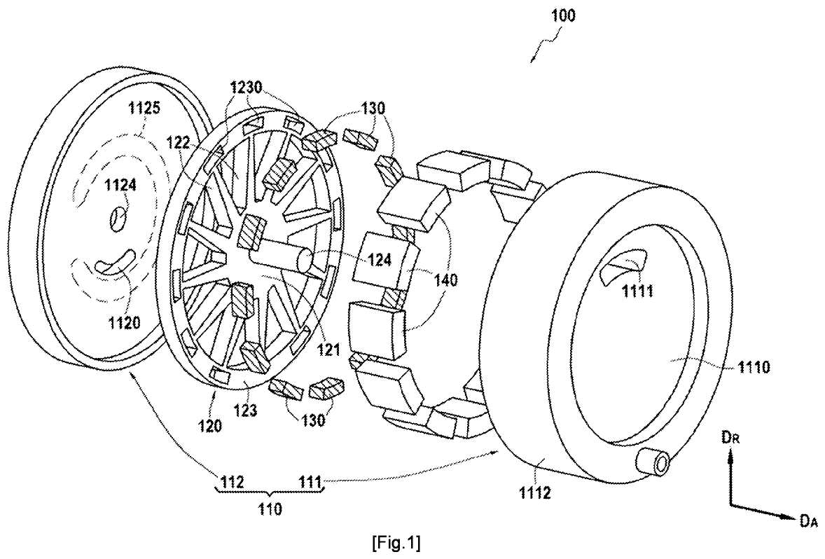

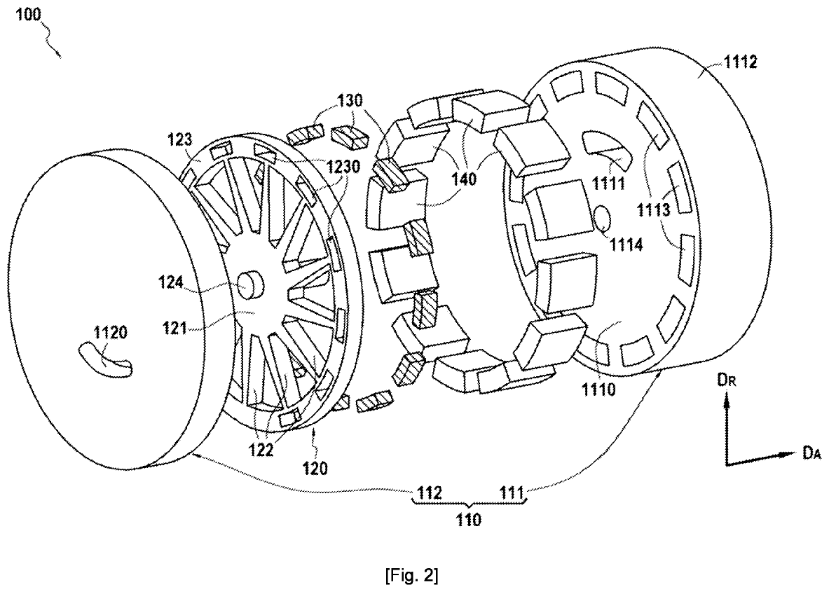

FIGS. 1 and 2 illustrate an electromagnetic pump 100 conforming with one embodiment of the invention. In the example described here, the electromagnetic pump 100 is a pump of the liquid ring type comprising a fixed pump body or stator 110 consisting of a casing 111 and of a flange 112. The casing 111 includes a solid cylindrical central portion 1110 provided with an aspiration/discharge port 1111 and a circular outer wall 1112 extending concentrically around the central portion 1110, annular recesses 1113 being delimited between the central portion 1110 and the outer wall 1112. The flange 112 includes a discharge/aspiration port 1120.

The electromagnetic pump 100 also comprises an impeller or rotor 120 comprising a wheel 121 provided with a plurality of vanes 122 extending from the wheel in a radial direction DR, a ring 123 being present at the outer periphery of the wheel. In the example described here, the ring 123 is fixed on the radially outer ends of the vanes 122. The impeller 120 includes a rotation shaft 124 intended to be supported by bearings 1114 and 1124 present respectively on the casing 111 and the flange 112. In known fashion in pumps of the liquid ring type, the shaft is placed eccentrically on the impeller 120, for example by means of a crossbar (not shown in FIGS. 1 and 2) so as to create variations of inter-vane (or inter-blade) volume which allow aspirating the fluid that is being pumped, for example through the port 1111, then delivering it under pressure, for example through the port 1120. The pump 100 can also be a lateral channel pump, also called a regenerative pump. In this case and in known fashion, a lateral channel 1125 (in dotted lines in FIG. 1), present here on the flange 112, extends between the ports 1111 and 1120. The evolution of the variations of inter-vane (or inter-blade) volume associated with the velocity field (vortex) present in the lateral channel 1125 allows aspirating the fluid, for example through the port 1111, then delivering it under pressure, for example through the port 1120. The electromagnetic pump 100 also comprises a plurality of permanent magnets 130 distributed annularly on the impeller or rotor 120, and a plurality of coils 140 distributed annularly inside the fixed pump body or stator 110. More precisely, in the example described here, the permanent magnets 130 are held in the recesses 1230 present in the ring 123 while the coils 140 are held in the annular recesses 1113 present in the casing 111.

Once all the elements constituting the pump 100 are assembled, the coils 140 are located facing permanent magnets 130 along an axial direction DA. In known fashion, the control of the electromagnetic pump 100 (torque and rotation speed) is accomplished by control of the current circulating in the coils.

By fixing the permanent magnets 130 directly to the impeller 120, a portion of the drive means of the pump are integrated directly within the moving elements, which allows obtaining a high level of integration of the drive means and therefore a reduced bulk for the pump.

In addition, by placing the plurality of permanent magnets and the plurality of coils facing one another along the axial direction, the radial bulk of the pump is greatly optimized. A very compact pump is thus obtained, which can be controlled independently relative to the engine speed of the turbomachine with which it is associated.

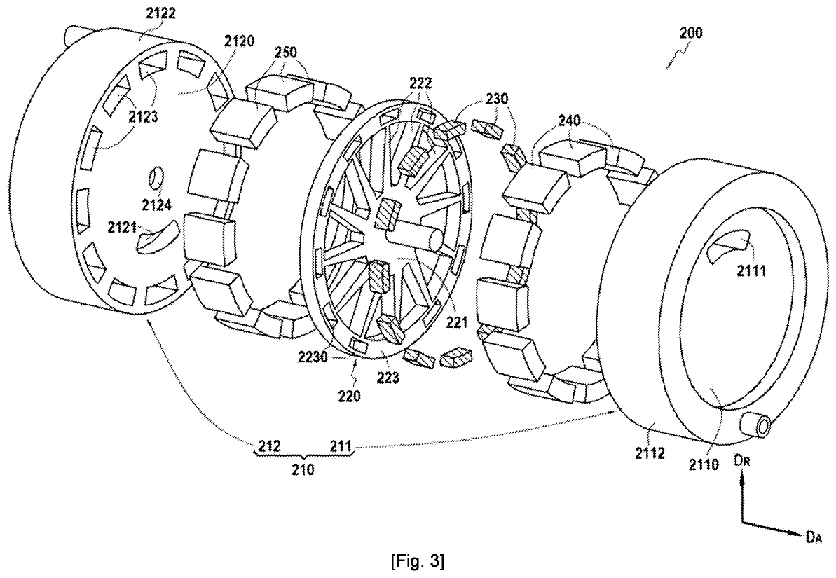

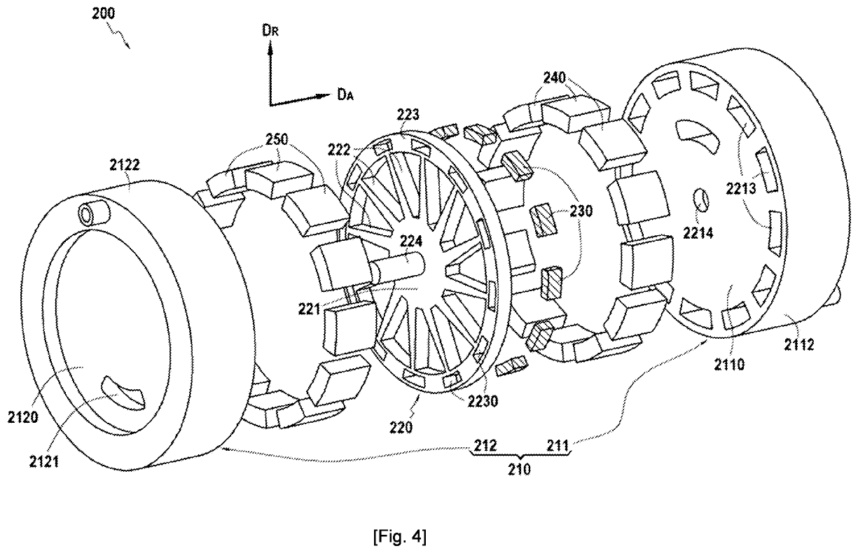

FIGS. 3 and 4 illustrate another embodiment of an electromagnetic pump 200 which differs from the electromagnetic pump 100 described in relation with FIGS. 1 and 2 in that it comprises dual coils. More precisely, as for the pump 100, the pump 200 comprises an impeller or rotor 220 comprising a wheel 221 provided with a plurality of vanes 222 extending from the wheel along a radial direction DR, a ring 223 fixed to the radially outer ends of the vanes 222.

The electromagnetic pump 200 also comprising a fixed pump body or stator 210 consisting of a first casing 211 and of a second casing 212. The casings 211 and 212 each include respectively a solid cylindrical central portion 2110, 2120 provided with an aspiration/discharge port 2111, 2121 and a circular outer wall 2112, 2122 extending concentrically around the central portion 2110, 2120. First annular recesses 2113 are delimited in the first casing 211 between the central portion 2110 and the outer wall 2112. Second annular recesses 2123 are delimited in the second casing 212 between the central portion 2120 and the outer wall 2122.

The electromagnetic pump 200 also comprises a plurality of permanent magnets 230 held annularly in recesses 2230 present in the ring 223, and first and second pluralities of coils 240 and 250. The first plurality of coils 240 is distributed annularly in the first annular recesses 2113 while the second plurality of coils 250 is distributed annularly in the second annular recesses 2123.

Once the pump 200 is assembled, the rotation shaft 224 of the impeller 220 is supported by the bearings 2214 and 2224, present respectively on the first and second casings 211 and 212, while the first and second pluralities of coils 240 and 250 are present respectively on one side and on the other side of the wheel 220 and facing the magnets along an axial direction DA.

In addition to the advantages of integration and compactness already mentioned earlier for the pump 100, the electromagnetic pump 200 comprises two pluralities of coils which allow ensuring redundancy in the case of a breakdown or a failure of one plurality of coils, each plurality of coils having its own connections to the control system. The redundancy of the plurality of coils can also be used to double the power of the electromagnetic fields to which the permanent magnets are subjected. It will also be noted that, always for the purpose of optimizing the bulk of the pump, only the plurality of coils is redundant, and this as close as possible to the permanent magnets.

The pump 200 can also be a lateral channel pump, also called a regenerative pump as previously explained in relation with the pump 100.

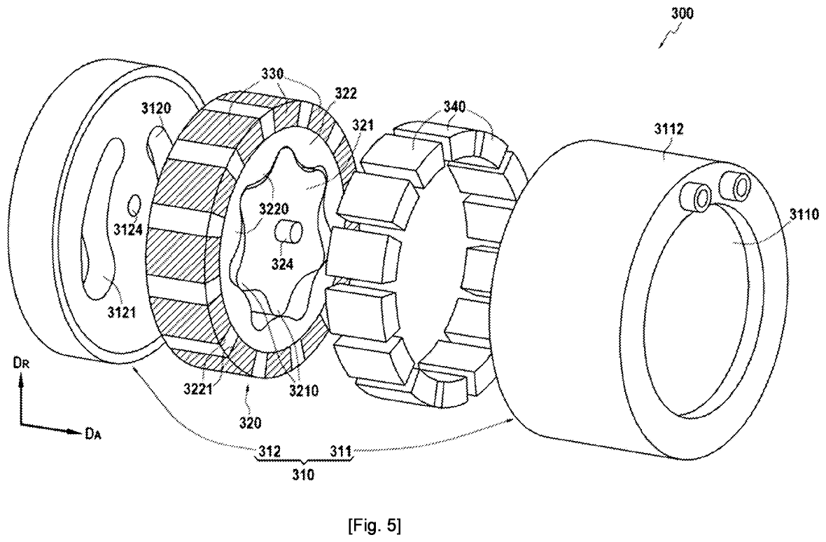

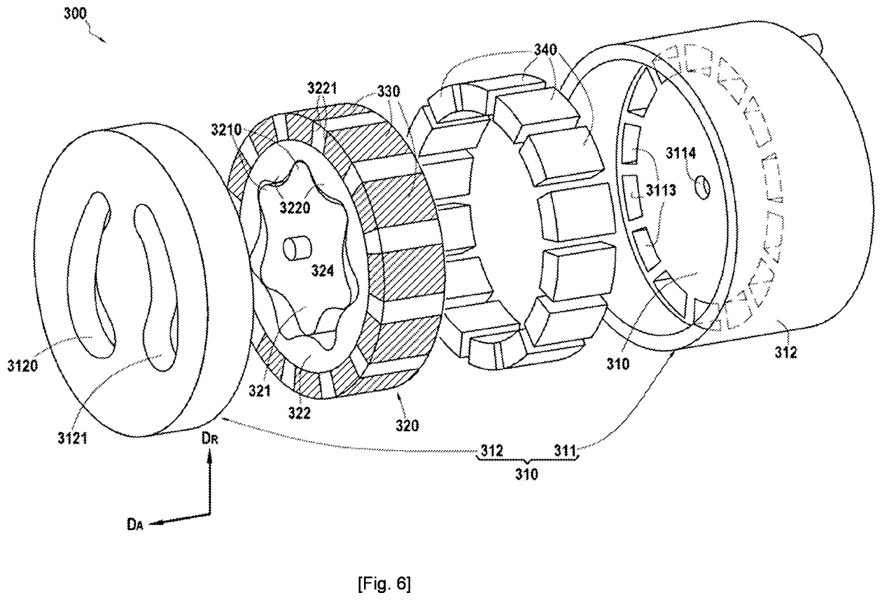

FIGS. 5 and 6 show an electromagnetic pump 300 conforming with another embodiment of the invention. In this embodiment, the pump 300 is a pump of the gerotor type comprising a fixed pump body or stator 310 consisting of a casing 311 and of a flange 312. The casing 311 includes a solid cylindrical central portion 3110 and a circular outer wall 3112 extending concentrically around the central portion 3110, annular recesses 3113 being delimited between the central portion 3110 and the outer wall 3112. The flange 312 includes an aspiration port 3120 and a discharge port 3121.

The electromagnetic pump 300 also comprises a rotor 320 comprising an inner gear 321 and an outer ring gear 322, present around the inner gear 321 along a radial direction DR. The inner gear comprises outer teeth consisting here of six teeth 3210 while the outer ring gear 322 comprises inner teeth consisting here of 7 teeth 3220. The inner gear 321 includes a rotation shaft 324 intended to be supported by bearings 3114 and 3124, present respectively on the casing 311 and the flange 312. In a manner known for pumps of the gerotor type, the fluid is aspired from the port 3120, then discharged via the port 3121 in capsules created between the teeth 3210 and 3220 respectively of the inner gear 321 and of the outer ring gear 322 during the rotation of these two elements.

The electromagnetic pump 300 also includes a plurality of permanent magnets 330 distributed annularly over the outer periphery of the outer ring gear 322, and a plurality of coils 340 distributed annularly inside the fixed pump body or stator 310. More precisely, in the example described here, the permanent magnets 330 are held in the recesses 3221 present in the outer ring gear 322 while the coils 340 are held in the annular recesses 3113 present in the casing 311.

Once all the elements constituting the pump 300 are assembled, the coils 340 are located facing the permanent magnets 330 along an axial direction DA. In known fashion, the control of the electromagnetic pump 300 (torque and speed of rotation) is accomplished by controlling the current circulating in the coils.

By fixing the permanent magnets directly 330 on the outer ring gear 322, a portion of the means for driving the pump is integrated directly within the moving elements, which allows obtaining a high level of integration of the driving means and therefor a reduced bulk for the pump.

In addition, by placing the plurality of permanent magnets and the plurality of coils facing one another along the axial direction, the radial bulk of the pump is greatly optimized. A very compact pump is thus obtained, which can be controlled independently relative to the engine speed of the turbomachine with which it is associated.

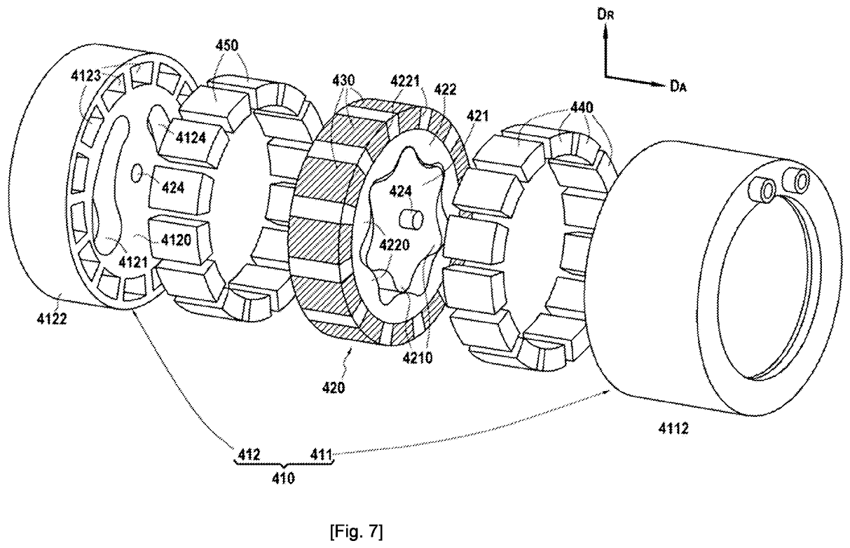

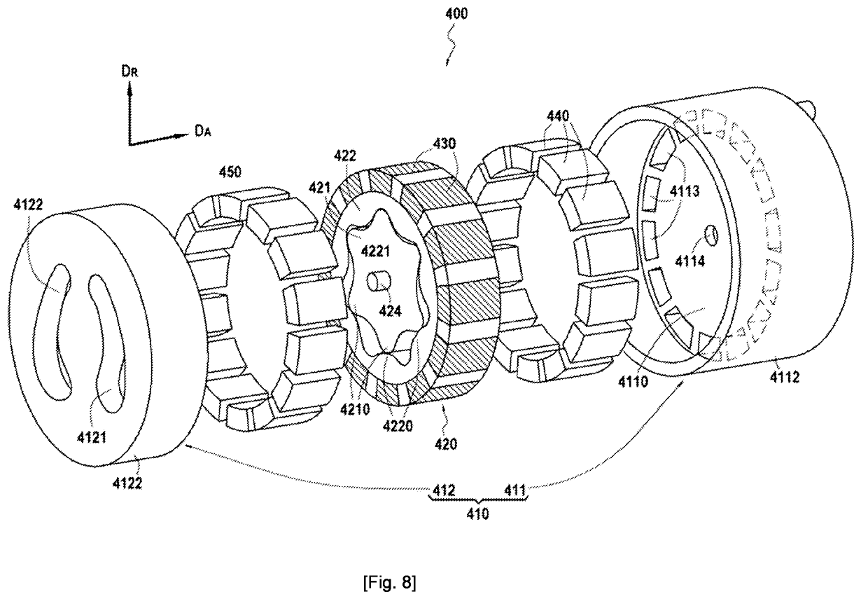

FIGS. 7 and 8 illustrate another embodiment of an electromagnetic pump 400 which differs from the electromagnetic pump 300 described in relation with FIGS. 5 and 6 in that it comprises dual coils. More precisely, as for the pump 300, the pump 400 comprises a rotor 420 comprising an inner gear 421 having outside teeth consisting here of six teeth 4210 and an outer ring gear 422 having inner teeth consisting here of 7 teeth 4220, the outer ring gear 422 being present around the inner gear 421 along a radial direction DR. The electromagnetic pump 400 also comprises a fixed pump body or stator 410 consisting of a first casing 411 and of a second casing 412. The casings 411 and 412 each include respectively a solid cylindrical central portion 4110, 4120 and a circular outer wall 4112, 4122 extending concentrically around the central portion 4110, 4120, the central portion 4120 of the casing 412 including an aspiration port 4121 and a discharge port 4124. First annular recesses 4113 are delimited in the first casing 411 between the central portion 4110 and the outer wall 4112. A second annular recess 4123 is delimited in the second casing 412 between the central portion 4120 and the outer wall 4122.

The electromagnetic pump 400 also comprises a plurality of permanent magnets 430 held annularly in recesses 4221 present in the outer ring gear 422 and first and second pluralities of coils 440 and 450.

The first plurality of coils 440 is distributed annularly in the first annular recesses 4113 while the second plurality of coils 450 is distributed annularly in the second annular recesses 4123.

Once the pump 400 is assembled, the rotation shaft 424 of the inner gear 421 is supported by bearings 4114 and 4124 present respectively on the first and second casings 411 and 412 while the first and second pluralities of coils 440 and 450 are present respectively on one side and on the other side of the outer ring gear 422 and facing the magnets along an axial direction DA.

In addition to the advantages of integration and of compactness already mentioned earlier for the pump 300, the electromagnetic pump 400 comprises two pluralities of coils which allow ensuring redundancy in case of breakdown or of failure of one plurality of coils, each plurality of coils having its own connections to the control system. The redundancy of the plurality of coils can also be used to double the power of the electromagnetic fields to which the permanent magnets are subjected. It will also be noted that, still with the purpose of optimizing the bulk of the pump, only the plurality of coils is redundant, this as close as possible to the permanent magnets.

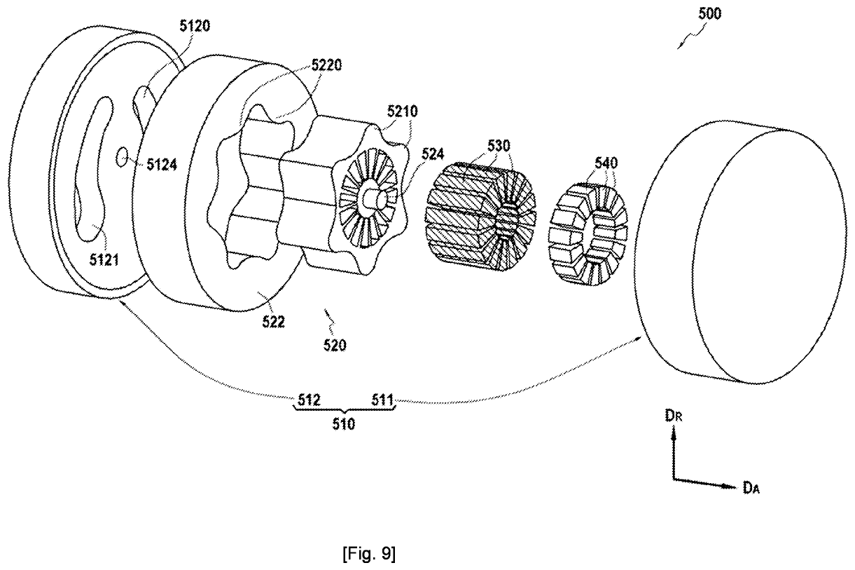

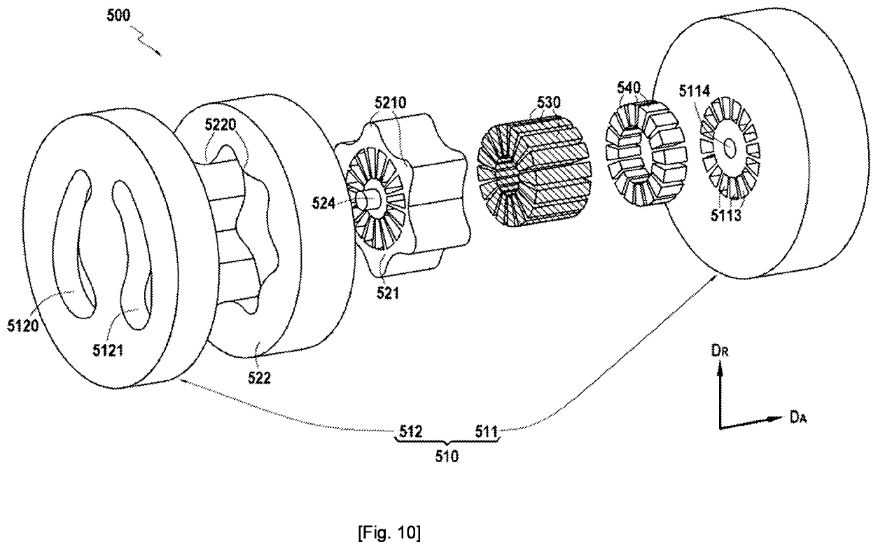

FIGS. 9 and 10 illustrate another embodiment of an electromagnetic pump 500 which differs from the electromagnetic pump 300 described in relation with FIGS. 5 and 6 in that the permanent magnets are held on the inner gear. More precisely, as for the pump 300, the pump 500 of the gerotor type comprises a fixed pump body or stator4 510 consisting of a casing 511 and of a flange 512. The casing 511 includes annular recesses 5113. The flange 512 includes an aspiration port 5120 and a discharge portion 5121.

The electromagnetic pump 500 also comprises a rotor 520 comprising an inner gear 521 and an outer ring gear 522, present around the inner gear 521 along a radial direction DR. The inner gear comprises outer teeth consisting here of six teeth 5210 while the outer ring gear 522 comprises inner teeth consisting here of 7 teeth 5220. The inner gear 521 includes a rotation shaft 524 intended to be supported by bearings 5114 and 5124 present respectively on the casing 511 and the flange 512.

The electromagnetic pump 500 also comprises a plurality of permanent magnets 530 held annularly in the inner gear 521 around the rotation shaft 524 and a plurality of coils 540 held in the annular recesses 5113 present in the casing 511.

Once all the elements constituting the pump 500 are assembled, the coils 540 are located facing the permanent magnets 530 along an axial direction DA. In known fashion, the control of the electromagnetic pump 500 (torque and speed of rotation) is accomplished by controlling the current circulating in the coils.

By fixing the permanent magnets direction 530 on the inner gear 321, a portion of the means for driving the pump is integrated directly within the moving elements, which allows obtaining a high level of integration of the driving means and therefore a reduced bulk for the pump.

In addition, by placing the plurality of magnets and the plurality of coils facing one another along the axial direction, the radial bulk of the pump is greatly optimized. A very compact pump is thus obtained which can be controlled independently relative to the engine speed of the turbomachine with which it is associated.

Just as for the pumps described previously, the electromagnetic pump 500 can be equipped with dual coils, namely comprise first and second pluralities of coils present respectively on one side and on the other side of the inner gear, the coils of the first and second pluralities facing the magnets along the axial direction.

According to an additional feature of the invention, the permanent magnets present on the outer ring of the impeller for the embodiments described earlier in relation to FIGS. 1 to 4, or on the outer ring gear for the embodiments described earlier in relation to FIGS. 5 to 8, or on the inner gear for the embodiment described earlier in relation to FIGS. 9 and 10, can be arranged according to a Halbach structure.

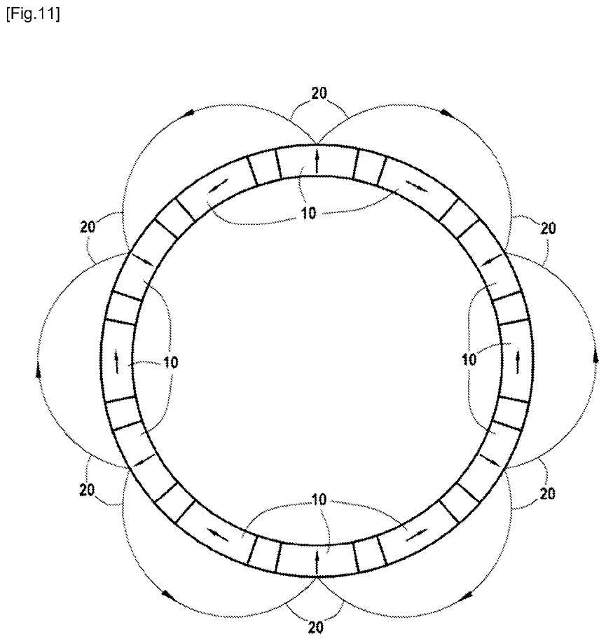

FIG. 11 illustrates an example of disposing permanent magnets according to a Halbach structure. In this example, permanent magnets 10 are distributed annularly as in the rotors described previously while inverting the polarity of the magnets in the radial direction and in the circumferential direction as shown by the arrows indicated in FIG. 11. This particular disposition allows increasing the magnetic field 20 on the outside of the rotor while the magnetic field on the inside of the rotor is substantially cancelled. The dissipation of the magnetic field is thus reduced, which improves the control of the rotor by the coils.

The electromagnetic pump according to the invention can in particular be used to supply the turbomachine with fuel or lubricant.

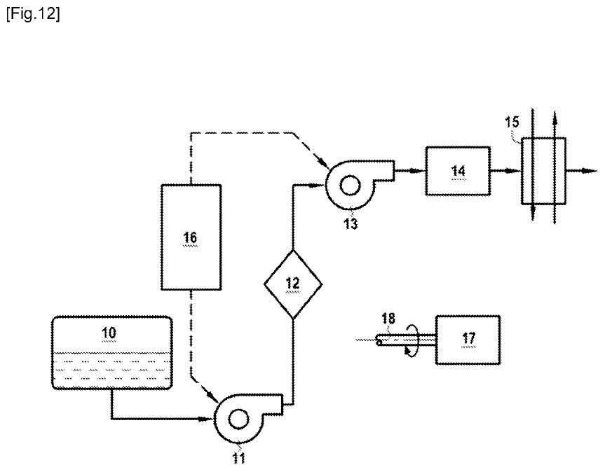

FIG. 12 illustrates an example of a turbomachine which includes a fuel supply line consisting here of a fuel reservoir 10, a low-pressure pump 11, a filter 12, a high-pressure pump 13, a metering device 14 and an oil/fuel heat exchanger 15. The turbomachine also comprises an accessory box 17 (“gear box”) to which is connected a drive shaft 18 intended to deliver mechanical power in the turbomachine. In conformity with the invention, the low-pressure pump 11 and the high-pressure pump 13 consist of an electromagnetic pump, for example of the liquid ring type or of the lateral channel or regenerative type. The low-pressure pump 11 and the high-pressure pump 13 are decoupled mechanically from the drive shaft 18 and are each controlled independently, for example by the digital computer 16 integrated with the control device of the turbomachine.

Regarding the oil supply circuit of a turbomachine, the low and/or high pressure feed pumps can also be replaced partially or totally by electromagnetic pumps controlled independently of the engine speed. In this case, pumps of the gerotor type are used preferably but not exclusively.

1. A turbomachine comprising a rotating spool comprising a drive shaft delivering mechanical power, wherein it comprises at least one electromagnetic pump mechanically decoupled from the drive shaft, each electromagnetic pump comprising at least one stator delimiting an annular internal volume wherein is present a rotor able to drive a fluid, a plurality of magnets distributed annularly on the rotor and at least one plurality of coils distributed annularly inside the stator, the coils of the plurality of coils facing the magnets along an axial direction.

2. The turbomachine according to claim 1, wherein the rotor comprises a wheel provided with a plurality of vanes, the magnets of the plurality of magnets being held at the outer periphery of the wheel.

3. The turbomachine according to claim 2, wherein each electromagnetic pump comprises first and second pluralities of coils, present respectively on one side and on the other side of the wheel, the coils of the first and second pluralities of coils facing the magnets along the axial direction.

4. The turbomachine according to claim 1, wherein the rotor comprises an inner gear cooperating with an outer ring gear with inner teeth, the magnets of the plurality of magnets being held at the outer periphery of the outer ring gear.

5. The turbomachine according to claim 4, wherein each electromagnetic pump comprises first and second pluralities of coils, present respectively on one side and on the other side of the outer ring gear, the coils of the first and second pluralities of coils facing the magnets along the axial direction.

6. The turbomachine according to claim 1, wherein the rotor comprises an inner gear cooperating with an outer ring gear with inner teeth, the magnets of the plurality of magnets being held on the inner gear.

7. The turbomachine according to claim 6, wherein each electromagnetic pump comprises first and second pluralities of coils, present respectively on one side and on the other side of the gear, the coils of the first and second pluralities of coils facing the magnets along the axial direction.

8. The turbomachine according to claim 1, wherein the magnets of the plurality of magnets are arranged annularly in a Halbach structure.
